(19) United States
(12) Patent Application Publication
(10) Pub. No.: US 2008/0298642 A1
(43) Pub. Date: Dec. 4, 2008

(54) Method and apparatus for extraction and matching of biometric detail

(75) Inventor: Peter M. Meenen, Germantown, TN (US)

Correspondence Address: Russell H. Walker;Walker, McKenzie & Walker, P.C., Suite 434, 6363 Poplar Avenue, Memphis, TN, 38119-4896, US

(73) Assignee: Snowflake Technologies Corporation, Memphis, TN (US)

(21) Appl. No.: 11/593,708

(22) Filed: Nov. 3, 2006

(51) Int. Cl. G06K 9/00

(52) U.S. Cl. 382/115

(57) ABSTRACT

A method and apparatus of identification by extracting and matching biometric detail from a subcutaneous vein infrared image. The image's Region of Interest is identified and artifacts are removed. A bank of filters, such as Symmetric Gabor Filters, Complex Gabor Filters, Log Gabor Filters, Oriented Gaussian Functions, or Wavelets, filters the image into a set of key value images that are subdivided into regions. An enrollment key, defined by ordered statistical measures of pixel intensities within the regions, is compared using a distance metric to a stored verification key. Various statistical measures may be used, such as variance, standard deviation, mean, absolute average deviation, max value, min value, max absolute value, median value, or a combination of these statistical measures. Various distance metrics may be used, such as Euclidean, Hamming, Euclidean Squared, Manhattan, Pearson Correlation, Pearson Squared Correlation, Chebychev, or Spearman Rank Correlation.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to identification of individuals using biometric information and, in particular, to identification and authentication of individuals using subcutaneous vein images.

2. Information Disclosure Statement

Biometrics, which refers to identification or authentication based on physical or behavioral characteristics, is being increasingly adopted to provide positive identification with a high degree of confidence, and it is often desired to identify and/or authenticate the identity of individuals using biometric information, whether by 1:1 (one to one) authentication or 1:n (one to many) matching/identification. It shall be understood that the terms “identify” and “identifying”, as used herein, refer both to authentication (verification that a person is who he or she purports to be) and to identification (determining which of a set of possible individuals a person is). Prior art solutions are known that use biometric information from iris images, images of palm print creases, and fingerprint images.

Daugman, U.S. Pat. No. 5,291,560 (issued Mar. 1, 1994), discloses performing biometric identification using analysis of oriented textures in iris images with a Hamming Distance metric, and it is known to use fixed-length keys when performing biometric identification based upon iris images.

Zhang et al., U.S. Patent Application Publication No. 2005/0281438 (published Dec. 22, 2005), discloses biometric identification using analysis of images of palm print creases with a neurophysiology-based Gabor Filter and an angular distance metric.

Jain, A. K.; Prabhakar, S.; Hong, L.; and Pankanti, S., “Filterbank-based Fingerprint Matching”, IEEE Trans. on Image Processing, pp. 846-859 (Vol. 9, No. 5, May 2000), discloses biometric identification with limited success using analysis of fingerprint images with Gabor Filters and a Euclidean distance metric.

Lee, Chih-Jen; and Wang, Sheng-De, “A Gabor Filter-Based Approach to Fingerprint Recognition”, 1999 IEEE Workshop on Signal Processing Systems, pp. 371-378 (October 1999), discloses using a Gabor filter-based method to do local ridge orientation, core point detection, and feature extraction for fingerprint recognition.

Jain, A. K.; Prabhakar, S.; Hong, L.; and Pankanti, S., “FingerCode: A Filterbank for Fingerprint Representation and Matching”, Proc. IEEE Conf. on CVPR, pp. 187-193 (Vol. 2, Jun. 23-25, 1999), discloses using a bank of Gabor filters to capture fingerprint details and performing fingerprint matching based on an Euclidean distance metric.

Prabhakar, S., “Fingerprint Classification and Matching Using a Filterbank”, Ph.D. Dissertation, Michigan State University (2001), discloses feature extraction and filterbank based matching of fingerprints using various algorithms.

Jain, A. K; Prabhakar, S.; and Hong, L., “A Multichannel Approach to Fingerprint Classification”, IEEE Transactions on PAMI, pp. 348-359 (Vol. 4, April 1999), discloses classifying fingerprints by filtering an image of a fingerprint by a bank of Gabor filters with a two-stage classification.

Horton, M.; Meenen, P.; Adhami, R.; and Cox, P., “The Costs and Benefits of Using Complex 2-D Gabor Filters in a Filter-Based Fingerprint Matching System”, Proceedings of the Thirty-fourth Southeastern Symposium on System Theory, pp. 171- 175 (Mar. 18-19, 2002), discloses applying two-dimensional Gabor filters to fingerprint images for matching fingerprints.

Zeman et al., U.S. Patent Application Publication No. 2006/0122515 (published Jun. 8, 2006); Zeman, U.S. Patent Application Publication No. 2004/0111030 (published Jun. 10, 2004); and Zeman, U.S. Pat. No. 6,556,858 (issued Apr. 29, 2003), fully incorporated herein by reference, disclose using infrared light to view subcutaneous veins, with subsequent re-projection of the vein image onto the surface of the skin, but does not disclose identification or authentication of individuals using the vein images.

Cross, J. M.; and Smith, C. L., “Thermographic Imaging of the Subcutaneous Vascular Network of the Back of the Hand for Biometric Identification”, Proc. IEEE 1995 Int'l Carnahan Conference on Security Technology, pp. 20-35 (Oct. 18-20, 1995), discloses making an infrared image of subcutaneous veins on the back of the hand and then segmenting the vein pattern to obtain a medial axis representation of the vein pattern. Contrast enhancement, filtering to remove hair and artifacts, and separation of the hand from a background is disclosed. The medial axis representations are compared against stored signatures in a database.

Im, S.; Park, H.; Kim, S.; Chung, C.; and Choi, H., “Improved Vein Pattern Extracting Algorithm and Its Implementation”, Int'l Conf. on Consumer Electronics—Digest of Technical Papers, pp. 2-3 (Jun. 13-15, 2000), discloses extracting a region of interest (“ROI”) from a vein image, using a Gaussian low-pass filter on the ROI image, and using a modified median filter to remove noise in the image caused by hair, curvature, and thickness of fatty substances under the skin.

Lin, C.; and Fan, K., “Biometric Verification Using Thermal Images of Palm-Dorsa Vein Patterns”, 14 IEEE Trans. on Circuits and Systems for Video Tech., pp. 199-213 (February 2004), discloses obtaining thermal images of palm-dorsa vein patterns, extracting a region of interest (“ROI”), and using moment filters to extract feature information about intensity, gradient, and direction features.

Tanaka, T.; and Kubo, N., “Biometric Authentication by Hand Vein Patterns”, SICE Annual Conf. in Sapporo, pp. 249-253 (Aug. 4-6, 2004), discloses obtaining near-infrared hand vein images, contrast-enhancing the images, and using phase-only correlation and template matching as a recognition algorithm.

Zhang, Z.; Wu, D. Y.; Ma, S.; and Ma, J., “Multiscale Feature Extraction of Finger-Vein Patterns Based on Wavelet and Local Interconnection Structure Neural Network”, Int'l Conf. on Neural Networks and Brain, pp. 1081-1084 (October 2005), discloses obtaining near-infrared images of finger veins, and using multi-scale self-adaptive enhancement transforms on the images using a wavelet analysis. A neural network is iteratively trained to perform recognition.

MacGregor, P; and Welford, R., “Veincheck: Imaging for Security and Personnel Identification”, 6 Advanced Imaging, pp. 52-56 (1991), discloses using infrared images of back of hand subcutaneous vein patterns whose nodes and connectivity mapped onto a hexagonal grid as a biometric identifier, using a histogram for verification.

Current vein-based biometric systems, as, for example, disclosed in Choi, U.S. Pat. No. 6,301,375 (issued Oct. 9, 2001), fully included by reference herein, utilize information such as points where veins intersect or cross, or, as disclosed in Clayden, U.S. Pat. No. 5,787,185 (issued Jul. 28, 1998), fully included by reference herein, utilize directionally-weighted vector representations of the veins, or other so-called “point-based” techniques well-known in the prior art.

A point-based vein biometric system can be defined as a system that performs biometric identification based on a selected series of critical points from a vein structure, for example, where the veins branch or where veins have maximal points of curvature. The typical approach to finding these points involves first segmenting the vein structure from the rest of he image. The segmented vein structure is then typically reduced to a binary image and subsequently thinned to a series of single pixel lines. From this thinned version of the vein structure, vein intersection points can be easily identified. Other features, such as line curvature and line orientation, are also easily determined. The positions of these critical points along with other measures describing them (for example orientation angle or curvature value) are arranged into a vector and stored. Because these systems often miss some points or detect new points when processing different images of the same vein structure, the vectors that are constructed are of variable length, which makes quick database searches difficult.

When performing point-based matching, the input point set is first compared to a reference point set during an alignment phase. This typically occurs through the use of an affine transform, or similar method. Following the alignment of the points, a search is conducted for approximate correspondences between points from different keys. The total maximum number of corresponding points between the two key vectors is determined and from this a score is calculated. The score is compared to a threshold value and a decision is made as to whether a match has occurred.

While these point-based techniques are usable, they pose many problems. Due to sensor noise and other negative factors, there is no guarantee that the same set of points will be extracted each time an individual is authenticated/identified. Thus, such prior art approaches must be flexible and allow for missing and added point locations, which prevents them from being able to construct fixed-length keys that are always ordered in a uniform manner. As a result, the matching process is drastically complicated and it becomes difficult to quickly search large databases using approaches taught by the prior art.

It is therefore desirable to have a method and apparatus for biometric identification and authentication that extracts biometric detail from vein images to form keys of fixed size and constant order so that key comparison may be quickly and efficiently performed. It is further desirable to reduce the computational difficulty of key comparison, and to improve the speed of matching, by using key subsets to identify possible match candidates, and then only performing full key comparisons on those possible match candidates.

None of these prior art references, either singly or in combination, disclose or suggest the present invention.

### BRIEF SUMMARY OF THE INVENTION

The present invention uses a series of filters to extract useful information from an image containing subcutaneous vein patterns. A region of interest (“ROI”) of an image containing subcutaneous vein structures, obtained from a vein imaging device, is processed using a plurality of filters that are selective in both orientation and spatial frequency. Once processed, statistical measures are taken from a plurality of regions within each of the resulting filtered images. These statistical measures are then arranged in a specific order and used as a uniquely-identifying code that can be quickly and easily matched against other codes that were previously acquired. Due to the uniform key size and constant ordering of the values, a metric as simple as a Euclidean Distance or preferably a Pearson Correlation Distance may be used to determine key similarity.

The present invention extracts detail from images of subcutaneous veins. This extracted detail is used to form a fixed-length key of statistical values that are then ordered in a preselected manner. The present invention enables rapid matching and searching of databases of fixed-length biometric keys generated by the present invention. One use for the present invention is for one to one and one to many biometric comparisons of subcutaneous vein patterns.

The present invention has numerous advantages. The method of the invention produces a fixed-length biometric key based on biometric detail extracted from subcutaneous vein images. The key, being of fixed length and in a constant order, permits rapid 1:1 (one to one) matching/authentication and makes the process of 1:n (one to many) matching/identification extremely simple.

The present invention also has the advantage of being able to simultaneously capture detail information relating to not only the position of veins, but also information relating to their size and orientation. This is due primarily to the fact that the filters applied to the image can be tuned in size, spatial frequency, and orientation. In any biometric system, the more information that can be captured relating to the feature in question, the better chance the system has of performing accurate matching for identification and authentication.

In the case of 1:n matching implementations, the present invention provides many benefits. First, since the key is of fixed size and in a constant order, the matching process is simpler, and as a result, matches can be performed more quickly. This allows a brute-force comparison with an entire database of keys to execute more quickly than would be possible under other prior art approaches. The present invention also allows for a more refined searching approach through a quick reduction of the size of the database that must be searched by matching on a subset of the key rather than on the full key. For example, to quickly narrow the search field down to a smaller subset of records, a comparison can be preformed using a smaller key generated from a subset of the filtered images such as, for example, a few strategically chosen filters. This results in fewer calculations than would have to be performed against all the records in the database. The full key can then be compared against the remaining records. In addition, by indexing the database of keys based upon specific features of the various sub-keys, comparisons against key values known to be substantially different from the key in question can be skipped.

It is an object of the present invention to provide an apparatus and method for identifying a person by extracting and matching biometric detail from a subcutaneous vein image of the person. It is a further object of the present invention that the identification be rapid and efficient.

### BRIEF DESCRIPTION OF THE SEVERAL VIEWS OF THE DRAWING

FIG. 1 is a schematic diagram of a preferred embodiment of the apparatus of the present invention, showing imaging of veins on a hand.

FIG. 2 is a view of a region of interest (“ROI”) of veins in an image.

FIG. 3 is a flowchart showing steps in the preferred embodiment of the method of the present invention.

FIG. 4 is a flowchart showing steps in the image preprocessing of FIG. 3.

FIG. 5 is a flowchart showing steps in the contrast enhancement of FIG. 4.

FIG. 6 is a graph of the one-dimensional Mexican Hat Wavelet for t=−32 to +32 and σ=8.

FIG. 7 is a two-dimensional directional (oriented) filter constructed from the Wavelet shown in FIG. 6.

FIG. 8 shows a representative pre-processed image before filtering.

FIG. 9 shows the image of FIG. 8 after filtering with an Even-Symmetric Gabor Filter.

FIG. 10 shows the image of FIG. 8 after filtering with two-dimensional Oriented Mexican Hat Wavelet Filter.

FIG. 11 shows how an image is processed into a key using the method of the present invention.

FIG. 12 is a flowchart showing steps in the key matching/verification.

FIG. 13A shows an image and FIG. 13B shows the resulting key produced by the image of FIG. 13A using the method of the present invention.

FIG. 14A shows another image from the same person as FIG. 13A but taken from a slightly different view, and FIG. 14B shows the resulting key produced by the image of FIG. 14A, showing how similar images (FIGS. 13A and 14A) produce similar keys (FIGS. 13B and 14B).

FIGS. 15A and 15B are the same as FIGS. 13A and 13B, and are for comparison purposes with the different image of FIG. 16A that produces the different key of FIG. 16B, showing how dissimilar vein patterns generate dissimilar keys.

FIGS. 17A, 18A, 19A, and 20A are different images with respective keys 17B, 18B, 19B, and 20B, for purposes of showing how similar images generate similar keys. The images of FIGS. 17A and 18A are somewhat similar, while the images of FIGS. 19A and 20A are very different from each other and from the images of FIGS. 17A and 18A.

FIGS. 21, 22, 23, and 24 show the match scores for the keys of FIGS. 17B, 18B, 19B, and 20B using various distance metrics. All match scores except those for the Pearson Correlation (FIG. 24) are normalized (divided) by the length of the key.

FIG. 25 shows comparison of two key subsets (“sub-keys”) using the keys shown in FIGS. 17B and 18B.

FIG. 26 shows comparison of one key subset against key subsets in a database of stored keys.

FIG. 27 shows rapid evaluation of one key subset against a database of stored keys indexed by subset key value counts to determine eligible keys for subsequent distance comparison.

FIG. 28 shows the combination of the techniques of FIGS. 26 and 27 for rapid evaluation of one key subset against a database of stored keys indexed by subset key value counts, which determines subsets eligible for subsequent key subset distance comparison, which determines keys eligible for full key distance comparison.

### DETAILED DESCRIPTION OF THE INVENTION

It is known in the prior art that skin and some other body tissues reflect infrared light in the near-infrared range of about 700 to 900 nanometers, while blood absorbs radiation in this range. Thus, in video images of body tissue taken under infrared illumination, blood vessels appear as dark lines against a lighter background of surrounding flesh. However, due to the reflective nature of subcutaneous fat, blood vessels that are disposed below significant deposits of such fat can be difficult or impossible to see when illuminated by direct light, that is, light that arrives generally from a single direction.

When an area of body tissue having a significant deposit of subcutaneous fat is imaged in near-infrared range under illumination of highly diffuse infrared light, there is significantly higher contrast between the blood vessels and surrounding flesh than when the tissue is viewed under direct infrared illumination. It appears that most of the diffuse infrared light reflected by the subcutaneous fat is directed away from the viewing direction. Thus, when highly diffuse infrared light is used to illuminate the tissue, the desired visual contrast between the blood vessels and the surrounding flesh is maintained. It should be noted that the infrared illumination can be reflective or transmitted, and that equivalent results can be achieved by illuminating the tissue with broad-spectrum light and then filtering out light that is outside the infrared before capturing an image of the illuminated tissue.

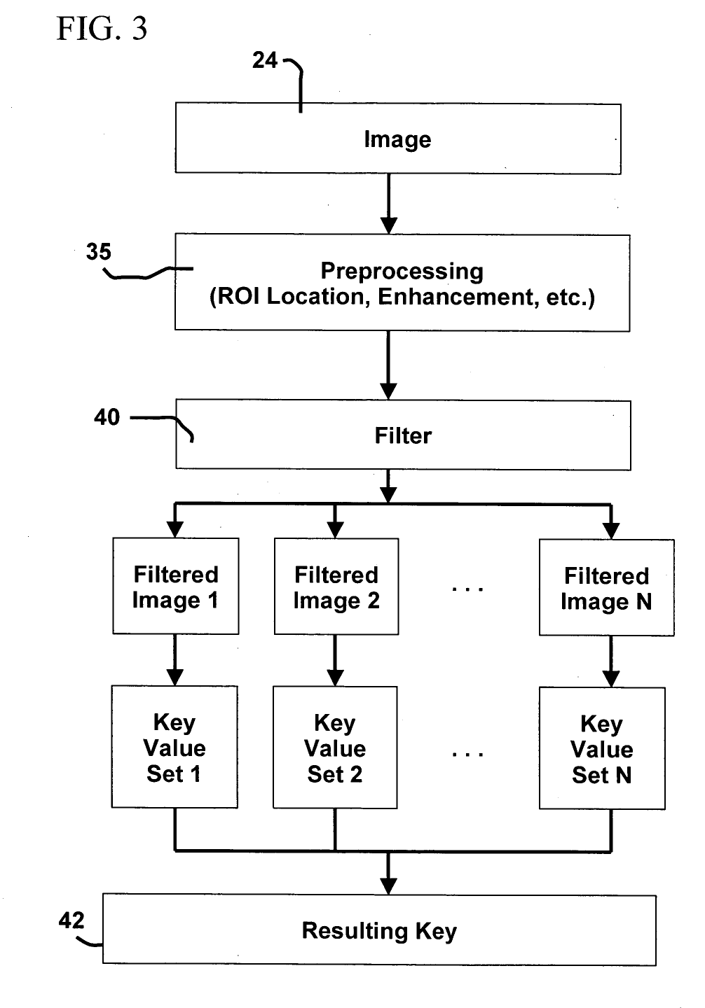

Briefly, before the details are fully explained, the method of the preferred embodiment of the invention has the steps shown in FIG. 3, and the apparatus of the present invention also operates according to the flow chart shown in FIG. 3. The steps include an input image 24 for which a region of interest (“ROI”) 30, perferably 400×400 pixels, has been identified and cropped; subdivision of the ROI into a tessellation pattern (such as preferably a 20 pixel×20 pixel square grid region, but polar sector regions, triangular regions, rectangular regions, or hexagonal regions, etc., may also be used) so as to form a plurality of regions; a bank of filters 40 (which can be selected from a wide variety of compatible filter types including, as described herein, Symmetric Gabor Filters, Complex Gabor Filters, Log Gabor Filters, Oriented Gaussian Functions, Adapted Wavelets (as that term is defined and used herein), etc.); and a statistical measure formed for each region in the tessellation pattern (preferably, statistical variance of the pixel intensities in the region, but there are numerous other statistical measures that could be used, including standard deviation, mean, absolute average deviation, max value, min value, max absolute value, and median value). It should also be noted that filters using the same orientations but different frequency values can be used to bring out details of different sizes i.e., larger and smaller veins. Also, more than one of these statistical measures could be used to increase the key size and to improve accuracy. For example, variance and mean values could be taken for each area and together arranged into a key. Finally, a comparison metric is used to compare the distance between an enrollment key and a stored verification key.

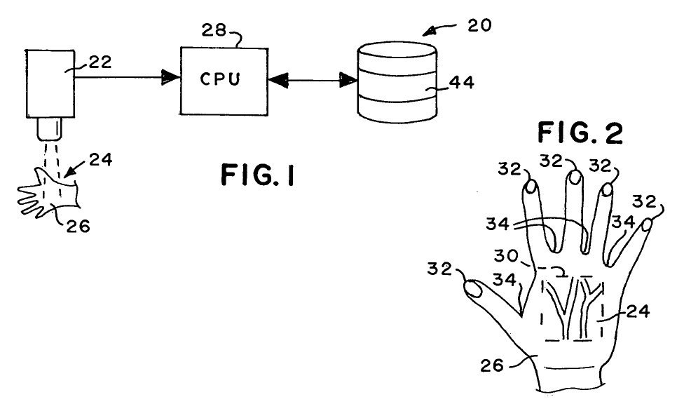

Referring to the figures of the drawings and especially to FIGS. 1-5, apparatus 20 for identifying a person is seen to include means 22, such as a well-known infrared camera, for capturing a subcutaneous vein infrared image 24 of the person. It shall be understood that the term “veins”, as used herein, is used to generically refer to blood vessels such as capillaries, veins, and arteries. A portion of the person, such as a hand 26, is illuminated by infrared light and then the image is captured by a camera 22 or other well-known sensing device. Alternatively and equivalently, broad-spectrum light (such as room light) could be used for illumination, and a suitable infrared filter could be placed in front of camera 22 to cause only the infrared image to be seen by camera 22. Camera 22 may include, as is well-known to those skilled in the art, charge-coupled device (“CCD”) elements, as are often found in well-known CCD/CMOS cameras, to capture the image and pass it on to a well-known computer 28.

While the present disclosure uses the example of vein patterns on the back of the hand for purposes of illustration, it should be understood that the present invention is easily adapted to work on other parts of the body where subcutaneous veins may be viewed.

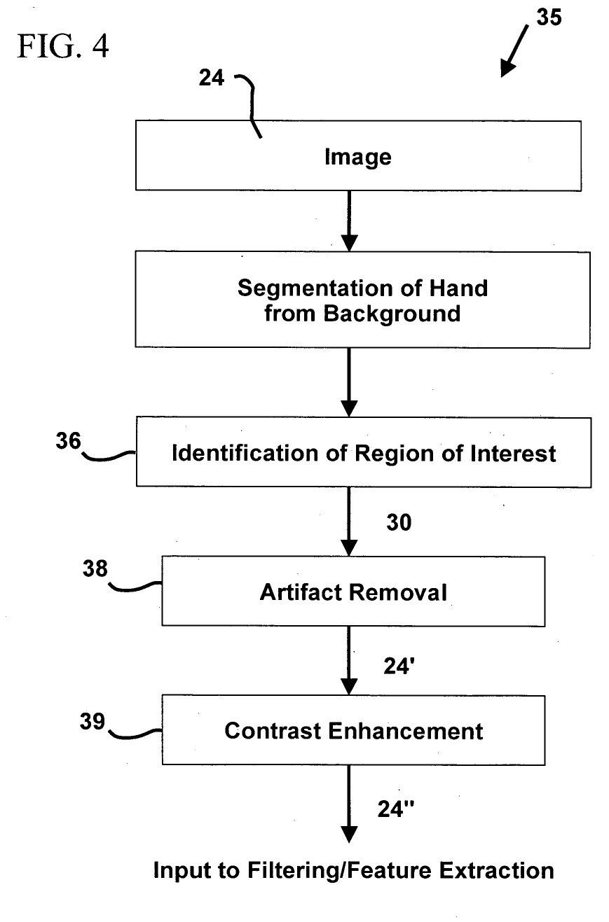

After the image 24 has been captured, preprocessing 35 is preferably performed on the image, and the preferred preprocessing steps of FIG. 3 are shown in greater detail in the flowchart of FIG. 4. In the preprocessing phase 35, a region of interest (“ROI”) 30 of the image 24 is identified for which processing will be performed. Preferably, this is done by segmenting the person's body part, e.g., hand 26, from any background image. Then, certain landmarks or feature locations, such as fingertip points 32 or preferably points 34 on the inter-finger webbing, are located. Fingertip points 32 are less desirable for landmarks than are inter-finger webbing points 34 because finger spread will cause greater variability of the location of fingertip points 32 with respect to ROI 30 than of the location of inter-finger points 34.

Based on the locations of these landmarks, the image is adjusted to a pre-defined location and orientation, preferably with adjustments for scaling, horizontal and vertical translation, and rotation, so that the ROI 30 will present a uniform image area of interest for evaluation. Once the image 24 has been thus scaled, translated, and oriented, the fixed ROI area 30 is defined, extracted from the image, and the remainder of the image 24 is discarded.

More specifically, the ROI 30 is identified as follows: First, the raw image 24 is received from the image capture means 22. Preferably a dark background is placed below the imaged hand 26 so that background pixels will be darker than foreground pixels of the hand. A histogram of the image 24 is taken, and the histogram is analyzed to find two peaks, one peak near zero (the background) and one peak in the higher-intensity range (the hand), and an appropriate threshold is determined that will discriminate the two peaks. If more than two peaks are found, the bin count is reduced by 5 until a two-peak histogram is achieved. If two peaks still cannot be found, a default threshold of 10 greater than the minimum pixel intensity (i.e., somewhat above the background intensity) is used. When two peaks are found, the threshold is set to the minimum value between these two peaks, and a binary mask is created with pixels having an intensity above the threshold being set to 1 and those equal or below the threshold set to 0.

The inter-finger points 34 are then located by tracing along the edge of the binary hand outline while noting local maximum and minimum elevations, where a “high” elevation is defined as being closer to the top of the image (using an orientation for the image capture means 22 such that the fingertips 32 are generally oriented toward the “top” of the image). A minimum elevation (closer to the “bottom” of the image) between two maximum elevations thus indicates an inter-finger point 34 on the inter-finger webbing. Once the inter-finger points 34 are located, an affine transform is used to rotate and scale the image 24 to match a set of pre-determined standardized points, with transform coefficients being determined using a least-squares mapping between the points on the imaged hand and the pre-determined standardized points.

The region of interest (ROI) 30 is then determined to be a 400×400 pixel region anchored at the inter-finger point 34 furthest from the thumb, noting that the thumb's inter-finger point has the lowest elevation in the y direction. To ensure an extra image border for padding in future filtering steps, a band of 100 pixels is preserved around the outside of the ROI when such a band of bordering pixels is available on the image. If there are fewer than 100 bordering pixels outside the ROI, existing pixels within the ROI are reflected to fill in these gaps of missing pixels.

Apparatus 20 is thus seen to include means 36 for identifying a region-of-interest.

Optionally, but preferably, the ROI image 30 may also be preprocessed (filtered) to remove artifacts in the image such as hair, as by well-known artifact removal means 38, to create an artifact-removed image 24′. This is not only to provide a more stable image for comparison, but also to prevent attempts by individuals to avoid identification by shaving the hair off of parts of their body. There are many ways to do artifact removal, but an adequate approach has been found to be by use of a simple and well-known 10×10 median filter. While this causes loss of some vein detail, the veins on the back of the hand (where hair removal is most needed) are large enough to easily survive a filter of size 10×10.

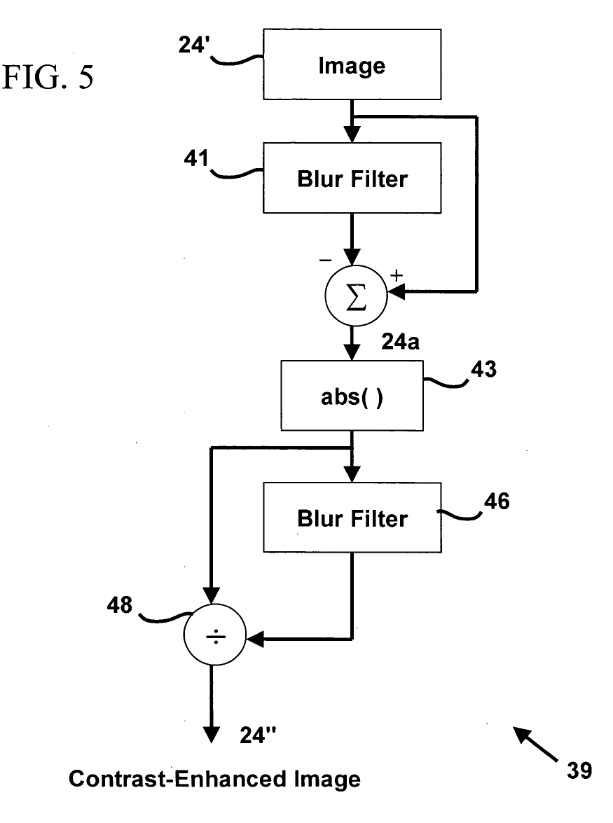

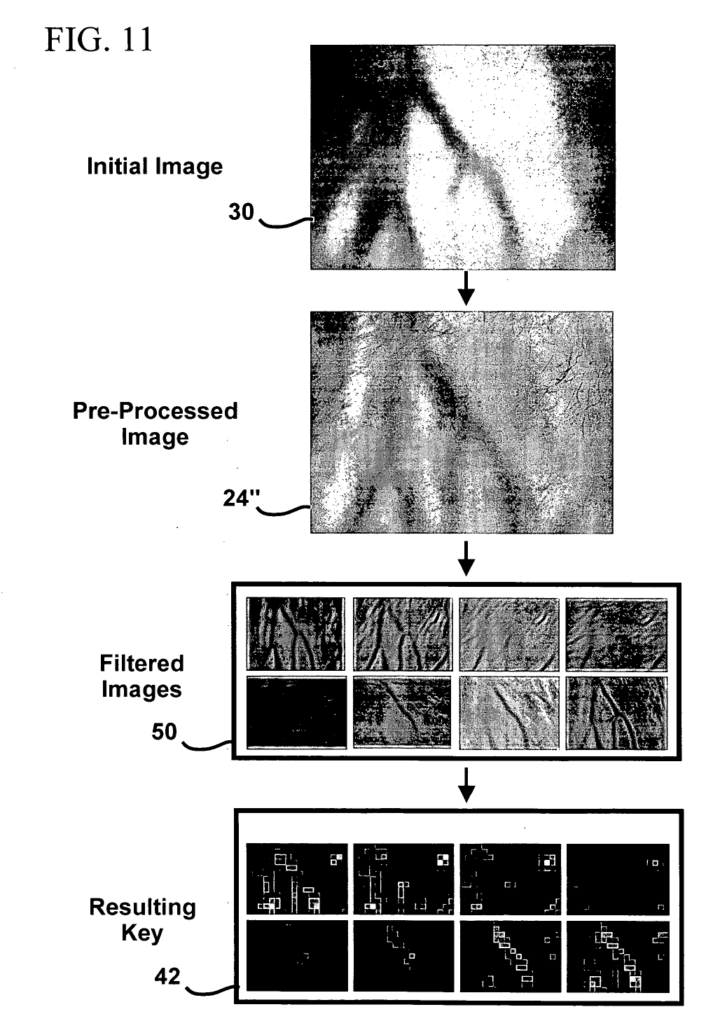

As a part of this preprocessing to remove artifacts, adaptive contrast enhancement 39 is then preferably performed on the image 24′ using steps as shown in detail in FIG. 5. An algorithm is used that first applies a blur filter 41 to the image to create a blurred version of the image, and then this blurred image is subtracted from the original image to create an unsharp version 24a of the image. The absolute value 43 is then taken of this unsharp image 24a, the absolute value processed image is then blurred 46, and the original unsharp image is divided 48 (point by point) by this blurred absolute value image, producing a contrast-enhanced image 24″. Additional image smoothing may also be used to clean up image artifacts produced by the hair removal. The “Pre-Processed Image” shown in FIG. 11 is an example of an initial image, shown at the top of FIG. 11, to which only contrast enhancement preprocessing has been done without removal of hair artifacts. Image pre-processing, while preferred, is not essential to the present invention.

It has been observed, however, that the approach of the present invention is sensitive to changes in the positions of vein detail in the image. In other words, the images that are compared by the present invention must be aligned very closely in order to allow for optimal matching. A good alignment method in the pre-processing stage is essential so that the ROI 30 location will be consistent. Proper alignment and location of the ROI 30 has been determined to be straightforward to accomplish on areas of the body that have a good set of landmark features, for example, the face, hands, etc., and feature matching is well-known to those skilled in the art.

With the pre-processing stage 39 completed, the ROI portion 30 of the image is ready for the application of a first plurality of enhancement filters 40. It shall be understood that this plurality of filters 40 may be implemented serially, at the expense of greater elapsed filtering time, or in parallel, at the expense of greater concurrent processing requirements. The preferred embodiment, for each of the filters 40, uses an Even Symmetric Gabor filter, which is of the form:

$$g ( x , y ) = {e}^{- \frac{1}{2} [ \frac{{[ x ( sin ( θ ) ) + y ( cos ( θ ) ) ]}^{2}}{{( {δ}_{x} )}^{2}} + \frac{{[ x ( cos ( θ ) ) - y ( sin ( θ ) ) ]}^{2}}{{( {δ}_{y} )}^{2}} ]} [ cos ( 2 π f [ x ( sin ( θ ) ) + y ( cos ( θ ) ) ] ) ]$$

where g(x, y) is the spatial representation of the Gabor filter, θ is the orientation angle of the desired filter, ƒ is the desired spatial frequency, and δₓ and δ_{y} represent the standard deviations of the Gaussian envelope in the x and y directions respectively.

In the preferred embodiment, eight Gabor filters of size 65 pixels×65 pixels are employed with the following filter parameters:

ƒ=1/40, δₓ=16, δ_{y}=16, θ={0°, 22.5°, 45°, 67.5°, 90°, 112.5°, 135°, 157.5°}

These eight filters are then independently applied to the pre-processed image 24″ to yield eight separate filter outputs 50 as shown in FIG. 11.

Filters other than Even Symmetric Gabor filters may be substituted for one or all of the filters 40, such as, for example, Complex Gabor Filters, Log Gabor filters, Oriented Gaussian Filters, and, as hereinafter explained in greater detail, filters constructed from Wavelets. Preferably all of the filters 40 are of the same class of filters but differing in orientation and/or frequency, and it shall be understood that other filters may be substituted that enhance image features for a given orientation angle. The well-known equations for several exemplary filters other than Even Symmetric Gabor filters will now be given.

The Complex Gabor Filter has the form:

$$g ( x , y ) = {e}^{- \frac{1}{2} [ \frac{{[ x ( sin ( θ ) ) + y ( cos ( θ ) ) ]}^{2}}{{( {δ}_{x} )}^{2}} + \frac{{[ x ( cos ( θ ) ) - y ( sin ( θ ) ) ]}^{2}}{{( {δ}_{y} )}^{2}} ]} {e}^{j2π f ( x sin ( θ ) + y cos ( θ ) )}$$

where g(x, y) is the spatial representation of the Gabor filter, θ is the orientation angle of the desired filter, ƒ is the desired spatial frequency (in degrees), and δₓ and δ_{y} represent the standard deviations of the Gaussian envelope in the x and y directions respectively.

The Log-Gabor filter is typically defined in the frequency domain. If spatial filtering is performed, the special filter is determined via inverse FFT. The frequency-domain representation of a 2-D Log-Gabor filter is:

$$LG ( u , v ) = {e}^{[ \frac{- {( \frac{ln ( r ( u , v ) )}{ω} )}^{2}}{2 {ln ( \frac{{σ}_{1}}{ω} )}^{2}} ]} {e}^{- [ \frac{{θ ( u , v )}^{2}}{2 {σ}_{2}^{2}} ]}$$

Where LG(u, v) is the frequency domain representation of the log-Gabor Filter, ω is the desired angular frequency, r(u, v) represents the radius of a given point in the filter from the filter's center, θ(u, v) is represents the desired orientation angle of the filter, σ₁ represents the spatial frequency bandwidth of the filter, and σ₂ represents the orientation bandwidth of the filter.

The Oriented Gaussian Filter has the form:

$$og ( x , y ) = {e}^{- \frac{1}{2} [ \frac{{[ x ( sin ( θ ) ) + y ( cos ( θ ) ) ]}^{2}}{{( {δ}_{x} )}^{2}} + \frac{{[ x ( cos ( θ ) ) - y ( sin ( θ ) ) ]}^{2}}{{( {δ}_{y} )}^{2}} ]}$$

where og(x, y) is the spatial representation of the oriented Gaussian filter, θ is the orientation angle of the desired filter, δₓ is the filter bandwidth in the x direction, and δ_{y} is the filter bandwidth in the y direction.

A Gabor filter is a preferable implementation of the key generation filter for the present invention because it is very effective at providing directionally selective enhancement. Most common two-dimensional wavelets are not extremely useful as directionally-enhancing filters because they typically provide little to no ability to easily select an orientation direction. There are, however, several one-dimensional wavelets that can, as hereinafter described, be adapted in such a way as to make them useful as directional key generation filters for the present invention. The identities of some of these wavelets and the strategy that can be employed to adapt them for use with the present invention can now be explained. The term “Adapted Wavelets”, as used herein, shall be understood to refer to one-dimensional wavelets adapted in accordance with the present invention, in a manner that can now be described in detail.

To be useful as key generation filters for the present invention, a wavelet filter must be capable of being oriented to a specific angle and must be scalable so that it can detect objects of varying size. By their very nature, wavelets are scalable and thus readily adaptable for detecting objects of varying size. Adaptation of a wavelet to be angularly selective for use with the present invention can be done in a manner that will now be described.

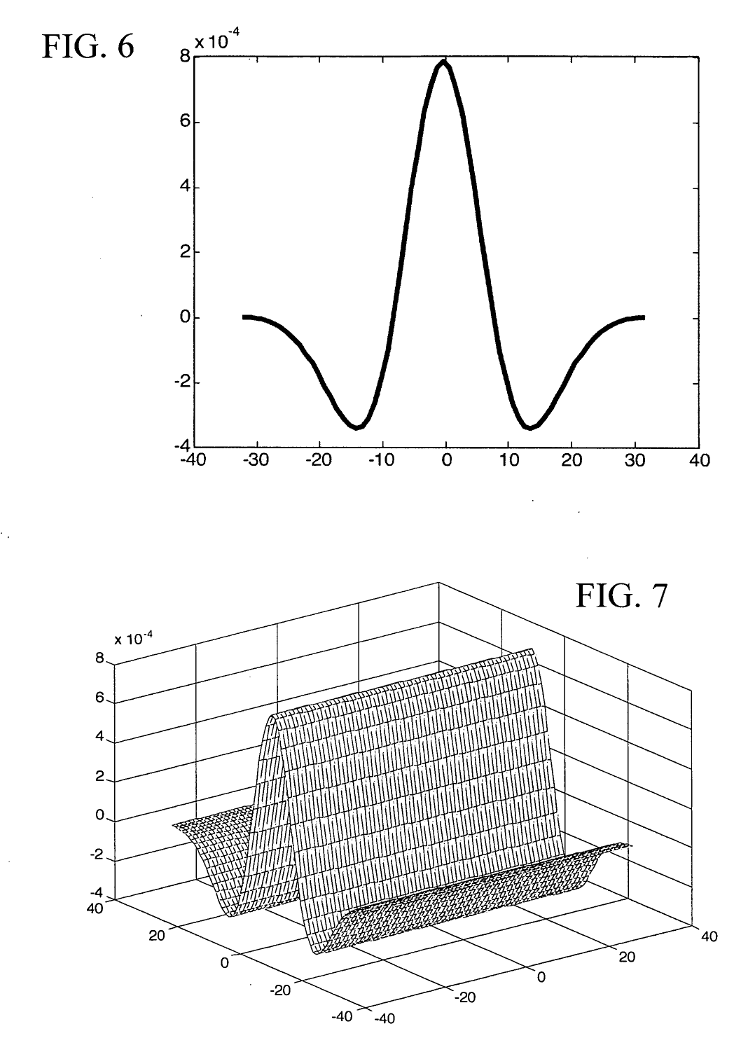

First, a one-dimensional wavelet is selected that has desired properties. For example, a Mexican Hat Wavelet has the following equation:

$$ψ ( t ) = ( \frac{1}{\sqrt{2 π} {σ}^{3}} ) ( ( 1 - \frac{{t}^{2}}{{σ}^{2}} ) {e}^{\frac{- {t}^{2}}{2 {σ}^{2}}} )$$

where t is time and σ is the standard deviation. This one-dimensional wavelet has a graph as shown in FIG. 6 for t=−32 to 32 and σ=8.

Then a two dimensional directional filter is created for an angle of zero degrees by repeating the one dimensional wavelet on every column of the two dimensional filter matrix as shown in FIG. 7.

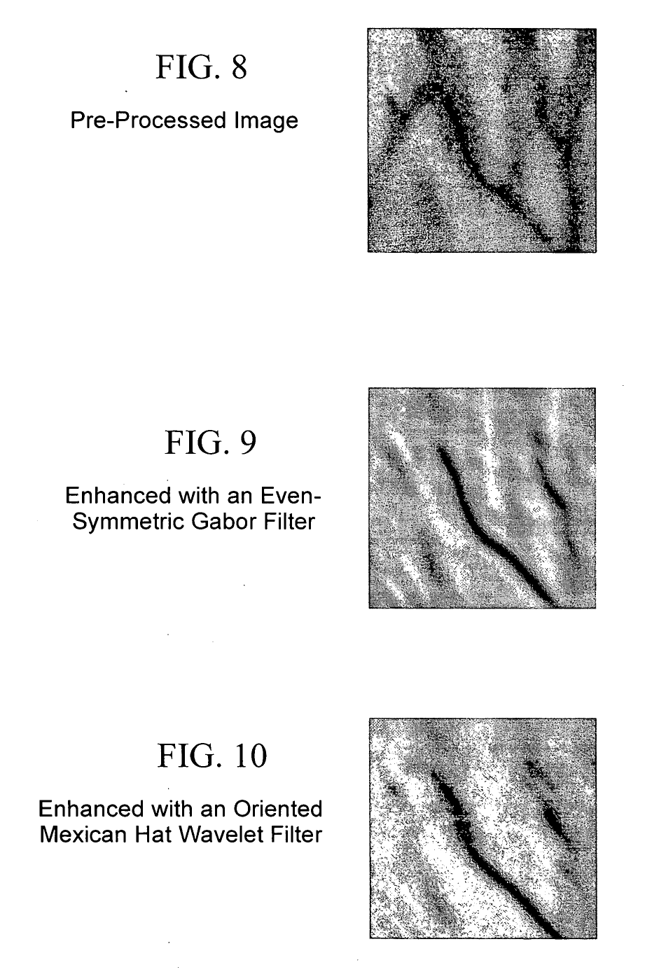

Next, a rotation operator is applied to the filter to orient it in the desired angle. An example of such a rotation operator utilizes a basic rotation matrix which is defined as:

$$[ \begin{matrix}{x}^{′} \\ {y}^{′}\end{matrix} ] = [ \begin{matrix}cos ( θ ) & - sin ( θ ) \\ sin ( θ ) & cos ( θ )\end{matrix} ] [ \begin{matrix}x \\ y\end{matrix} ]$$

where x′ and y′ represent the new filter coordinates, x and y represent the current filter coordinates, and θ is the angle of rotation. By performing this rotation for each desired angle of orientation, a series of directionally-enhancing filters are thus constructed. When applied to the image, these filters have a result similar to that of the Gabor filter used in the preferred embodiment of the invention. For example, the following demonstrates a 135 degree filter constructed as just described. The result of filtering an image (shown in FIG. 8) using this filter is shown as FIG. 10 next to, for comparison, the results shown in FIG. 9 of using a similarly-oriented Gabor filter.

There are several one dimensional wavelets that will work with the previously described method of oriented two-dimensional wavelet filter generation from a one-dimensional wavelet. Some of these include:

The Mexican Hat Wavelet, which has an equation of the form:

$$ψ ( t ) = ( \frac{1}{\sqrt{2 π} {σ}^{3}} ) ( ( 1 - \frac{{t}^{2}}{{σ}^{2}} ) {e}^{\frac{- {t}^{2}}{2 {σ}^{2}}} )$$

where t is time and σ is the standard deviation.

The Difference of Gaussians Wavelet (which can be used to approximate the Mexican Hat Wavelet), which has an equation of the form:

$$ψ ( t ) = \frac{1}{{σ}_{1} \sqrt{2 π}} {e}^{( - \frac{{( t - {μ}_{1} )}^{2}}{2 {σ}_{1}^{2}} )} - \frac{1}{{σ}_{2} \sqrt{2 π}} {e}^{( - \frac{{( t - {μ}_{2} )}^{2}}{2 {σ}_{2}^{2}} )}$$

where σ₁ and σ₂ are standard deviations and μ₁ and μ₂ are mean values.

The Morlet Wavelet, which has an equation of the form:

$$ψ ( t ) = {( 1 + {e}^{- {σ}^{2}} - 2 {e}^{- \frac{3}{4} {σ}^{2}} )}^{- \frac{1}{2}} {π}^{- \frac{1}{4}} {e}^{- \frac{1}{2} {t}^{2}} ( {e}^{iσ t} - {e}^{- \frac{1}{2} {σ}^{2}} )$$

where t is time and σ is the standard deviation.

Hermitian Wavelets, which are a family of wavelets of which the Mexican hat is a member. The n^{th} Hermitian wavelet is simply the n^{th} derivative of a Gaussian, and has an equation of the form:

$${ψ}_{n} ( t ) = {( 2 n )}^{- \frac{n}{2}} {c}_{n} {H}_{n} ( \frac{t}{\sqrt{n}} ) {e}^{- \frac{1}{2 n} {t}^{2}}$$

where Hₙ represents the n^{th} Hermite polynomial and cₙ is given by:

$${c}_{n} = {( {n}^{\frac{1}{2} - n} Γ ( n + \frac{1}{2} ) )}^{- \frac{1}{2}}$$

Additionally, discrete one-dimensional wavelets, such as the well-known Haar, Daubechies, Coiflet, and Symmlet wavelets, may also and equivalently be used. These wavelets are typically defined as a series of discrete values for which tables are well known to those skilled in the art.

The adapted wavelets heretofore described are intended to be examples of one-dimensional wavelets that can be adapted in accordance with the present invention to perform directional filtering enhancement of images in the matter heretofore described. Other one-dimensional wavelets having similar characteristics could be used in the manner heretofore described without departing from the spirit and scope of the present invention.

Now that the filters have been applied to the region of interest, an enrollment or first key 42 is generated.

The output of each filter is divided into a plurality of regions (20×20 pixels in the preferred embodiment), with each region having at least one pixel therewithin, and with each pixel having a pixel intensity. It should be understood that this region block size will change depending on the size of the features to be extracted.

For each region of each subdivided filter output, a statistical measure, preferably the statistical variance, of the pixel intensity values within the region is calculated. Note that, while the statistical measure used in the preferred embodiment is the statistical variance, many other statistical measures can be used, including standard deviation, mean, absolute average deviation, etc. In fact, it is possible to construct an enrollment key by using several of these measures together, yielding several statistical measures for each region. The important feature of the statistical measure is that areas of the image with high variance represent areas that were enhanced by the filter while areas of low variance were not. Thus, areas of high variance are statistically likely to represent the presence of a vein in an orientation similar to that of the filter. The magnitude of the variance is also an indicator of how closely the angle in which the vein is running matches the angle of the filter. Veins that run at an angle reasonably close to that of the filter will still show some response, but veins running at exactly the same angle will show a much larger response.

The statistical measures of the regions are then ordered so as to define an enrollment key vector 42, as by storing them in an array in a pre-set order. For meaningful comparison, it is essential that the ordering of the statistical measures of the enrollment key match the ordering of the statistical measures in the stored verification keys. If key size is of concern, the variance values may be scaled so that the largest is equal to 255 and the smallest is equal to zero, thereby allowing each value to occupy only one byte of storage space. These regions are visually represented in the drawings as patches of varying intensity, with black patches have a value of zero and white patches having a value of 255, within the eight key subsets that together comprise key vector 40 shown in FIG. 11. For additional storage space reduction, the keys can be reduced to a binary representation by applying a threshold value. In this binary version of the key, each block representation occupies only one bit, and thus, a large reduction in storage space is achieved. This is done at the cost of a reduction in matching accuracy, however.

The enrollment key 42 may then be stored to a disk 44 (joining a database of verification or second keys) or matched against an existing verification key to perform a verification or identification function.

The process of matching two keys (i.e., enrollment and verification keys) is straightforward, and there are multiple ways that key matching can be performed. In one embodiment, a simple Euclidian distance calculation is performed on the keys as a whole. In other words, if the first (or enrollment) key is represented as:

key₁={x₁, x₂, . . . , xₙ}

and the second (or verification) key is represented as:

key₂{y₁, y₂, . . . , yₙ},

the Euclidean Distance is determined as:

$$d = \sqrt{{\sum }_{i = 1}^{n} {( {x}_{i} - {y}_{i} )}^{2}}$$

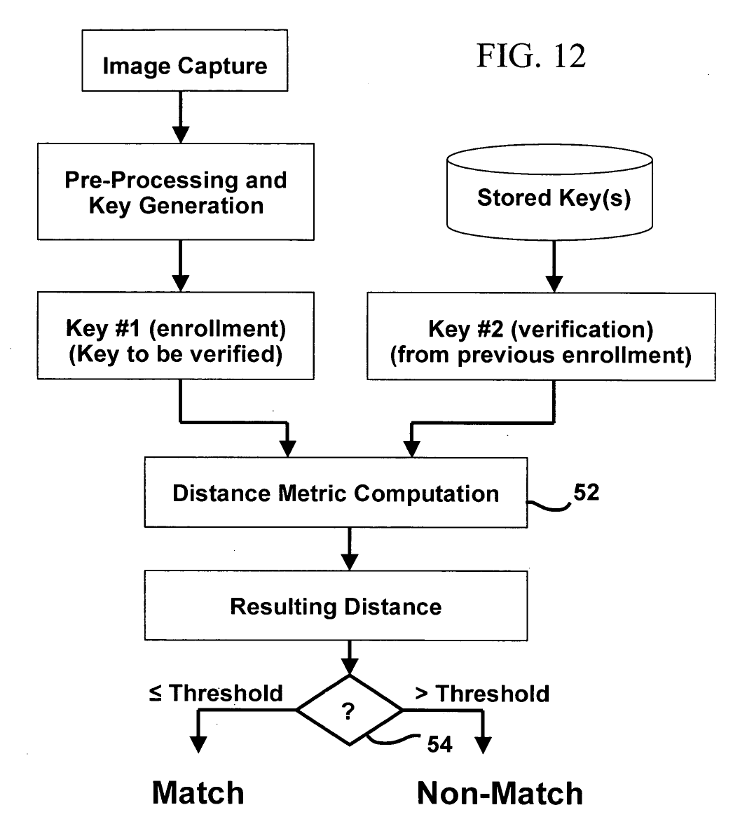

A flowchart of the matching steps performed by the present invention is shown in FIG. 12. The generated enrollment, or first, key is compared to a stored verification, or second, key using the chosen distance metric 52 as described above, and the determination of whether the two keys match is made using a preselected threshold distance comparison 54. If the distance between the two keys is larger than the preselected threshold distance, they do not match. If the calculated distance is below the threshold, the keys do match.

In practice, threshold values are set after running a tuning subset of vein images through the apparatus/method of the present invention and evaluating the resulting scores. A threshold score is then chosen to best reflect chosen security goals for false positive (acceptance/match) and false negative (missed match). For example, a preferred implementation using a Pearson Correlation, described in greater detail hereinbelow, and which has the advantage of being a normalized metric, utilizes a threshold score of 0.5. Anything below this distance (score) is a match, and anything above this distance is a non-match. Typical scores for matching keys have been found to range from about 0.15 to 0.3 and typical scores for non-matching keys have been found to range from about 0.6 to 1.0. Each of the distance metrics (scoring methods) described herein produces an output with a slightly different numerical range, and it is necessary that a particular implementation of the present invention determine acceptable match and non-match score thresholds that reflect the desired security goals of the implementation.

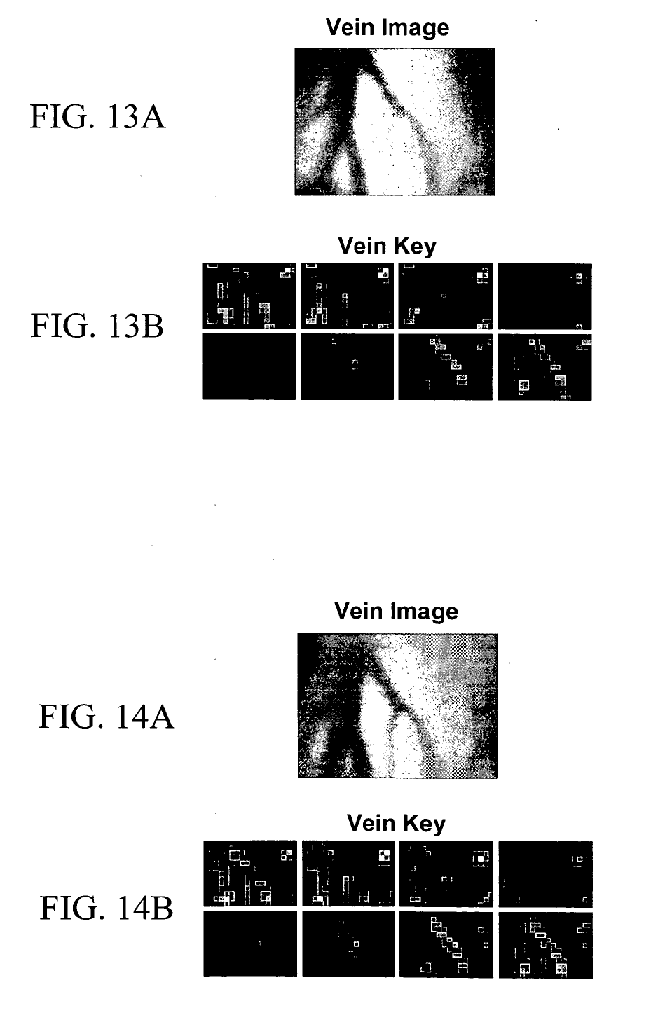

The matching step can be repeated across the database for a one to many match, or for more sophisticated matching for one to many approaches, some of the methods of database indexing using properties of the key could be employed. An example of keys generated from similar but non-identical vein images can be seen by comparison of FIG. 13A with FIG. 14A and of FIG. 13B with FIG. 14B. FIG. 13A shows an image and FIG. 13B shows the resulting key produced by the image of FIG. 13A using the method of the present invention. It shall be understood that all of the keys shown in the drawings are pictorial representations of the key vectors themselves, normalized to range from 0 (black) to 255 (white) for ease of visual comparison between keys. FIG. 14A shows another image from the same person as FIG. 13A but taken from a slightly different view, and FIG. 14B shows the resulting key produced by the image of FIG. 14A, showing how similar images (FIGS. 13A and 14A) produce similar keys (FIGS. 13B and 14B).

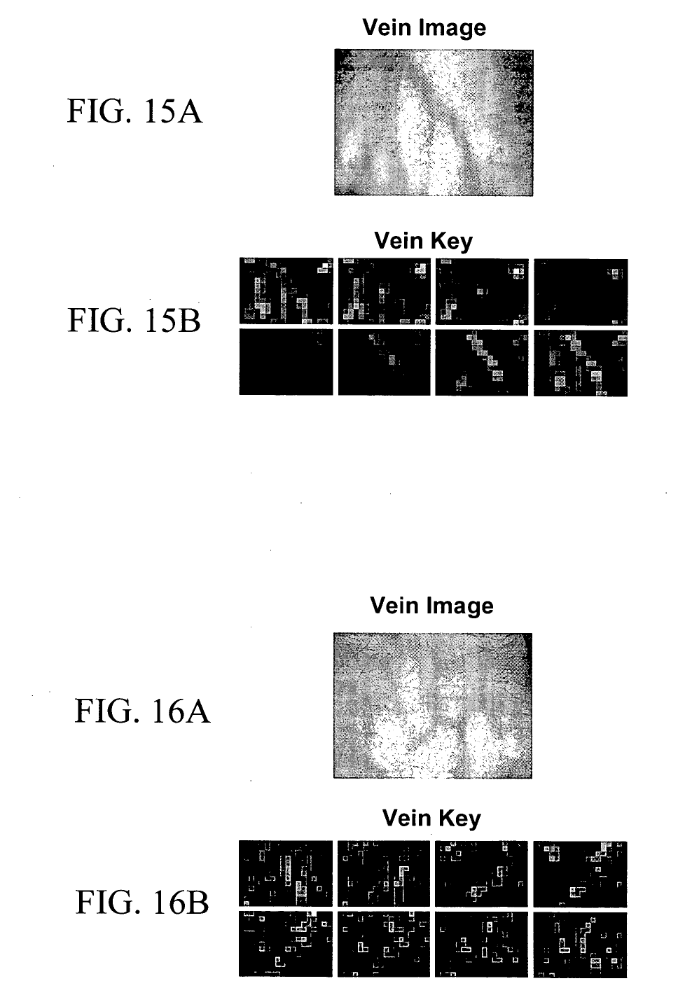

Likewise, an example of keys generated from dissimilar vein images can be seen by comparison of FIG. 15A with FIG. 16A and of FIG. 15B with FIG. 16B. FIGS. 15A and 15B are the same as FIGS. 13A and 13B, and are for comparison purposes with the different image of FIG. 16A that produces the different key of FIG. 16B, showing how dissimilar vein patterns generate dissimilar keys. Visible differences in key values can be noted between FIGS. 15B and 16B.

While the preferred embodiment uses the Euclidean distance of the points defined by the key as a whole as a comparison metric 54, there are a wide variety of other possibilities, including the Hamming Distance, the Euclidean Squared Distance, the Manhattan Distance, the Pearson Correlation Distance, the Pearson Squared Correlation Distance, the Chebychev Distance, the Spearman Rank Correlation Distance, etc.

The equations for these other distance metrics are well known, and for example, other well-known distance metrics may be used instead of the Euclidean distance.

Well-known equations for some of these other distance metrics that may be used in accordance with the present invention for the distance between the keys key₁ and key₂ will now be given.

The Euclidean Squared Distance has the form:

$$d = {\sum }_{i = 1}^{n} {( {x}_{i} - {y}_{i} )}^{2}$$

The Manhattan Distance (or Block Distance) has the form:

$$d = {\sum }_{i = 1}^{n} \vert {x}_{i} - {y}_{i} \vert$$

The Pearson Correlation Distance has the form:

$$d = 1 - r$$

$$where$$

$$r = \frac{Z ( x ) Z ( y )}{n} , \\ Z ( x ) = \frac{x - {μ}_{x}}{{σ}_{x}} , \\ Z ( y ) = \frac{y - {μ}_{y}}{{σ}_{y}} ,$$

μ is the mean, σ is the standard deviation, and n is the number of values in the sequences x and y. The Person Correlation, being a normalized distance, is a particularly preferable distance metric for practice of the present invention.

The Pearson Squared Correlation Distance has the form:

d=1−2r

with the same definitions as for the Pearson Correlation Distance.

The Chebychev Distance (or Maximum Single-Dimensional Distance) has the form:

d=maxᵢ|xᵢ−yᵢ|

The Spearman Rank Correlation Distance has the form:

$$d = 1 - \frac{6 {\sum }_{i = 1}^{n} {( rank ( {x}_{i} ) - rank ( {y}_{i} ) )}^{2}}{n ( {n}^{2} - 1 )}$$

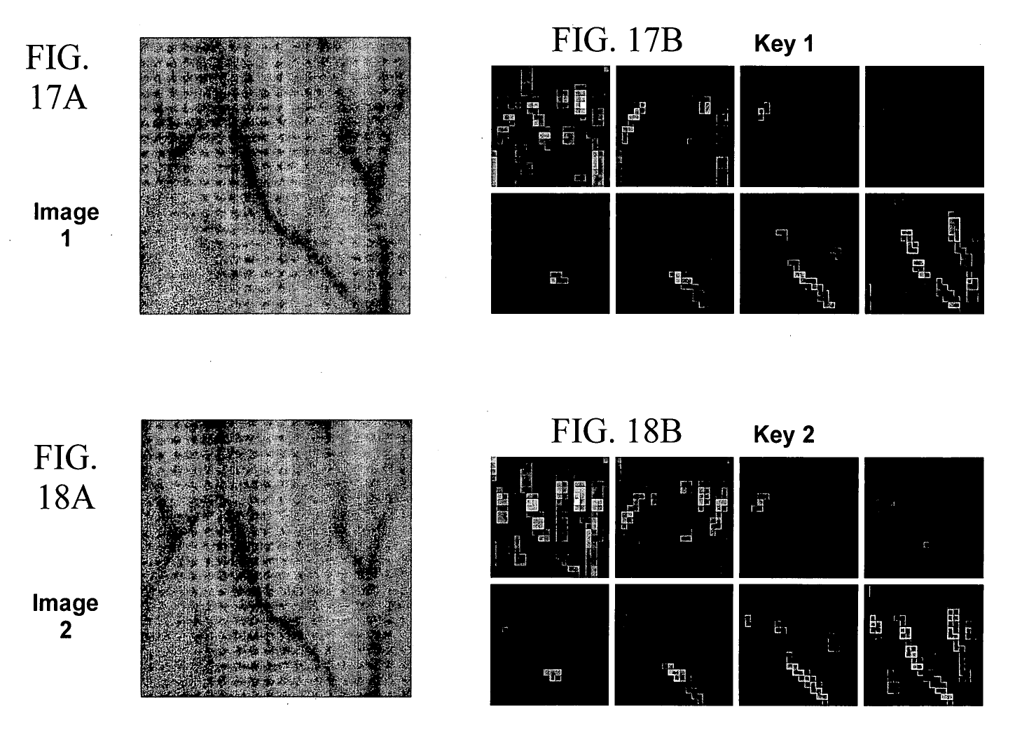

Referring to FIGS. 17A, 17B, 18A, 18B, 19A, 19B, 20A, 20B, and FIGS. 21-24, the performance of various distance metrics with different images can be seen. All keys were generated using the preferred embodiment of eight Even-Symmetric Gabor Filters of size 65 pixels×65 pixels with the following filter parameters:

ƒ=1/40, δₓ=16, δ_{y}=16, θ={0°, 22.5°, 45°, 67.5°, 90°, 112.5°, 135°, 157.5°}

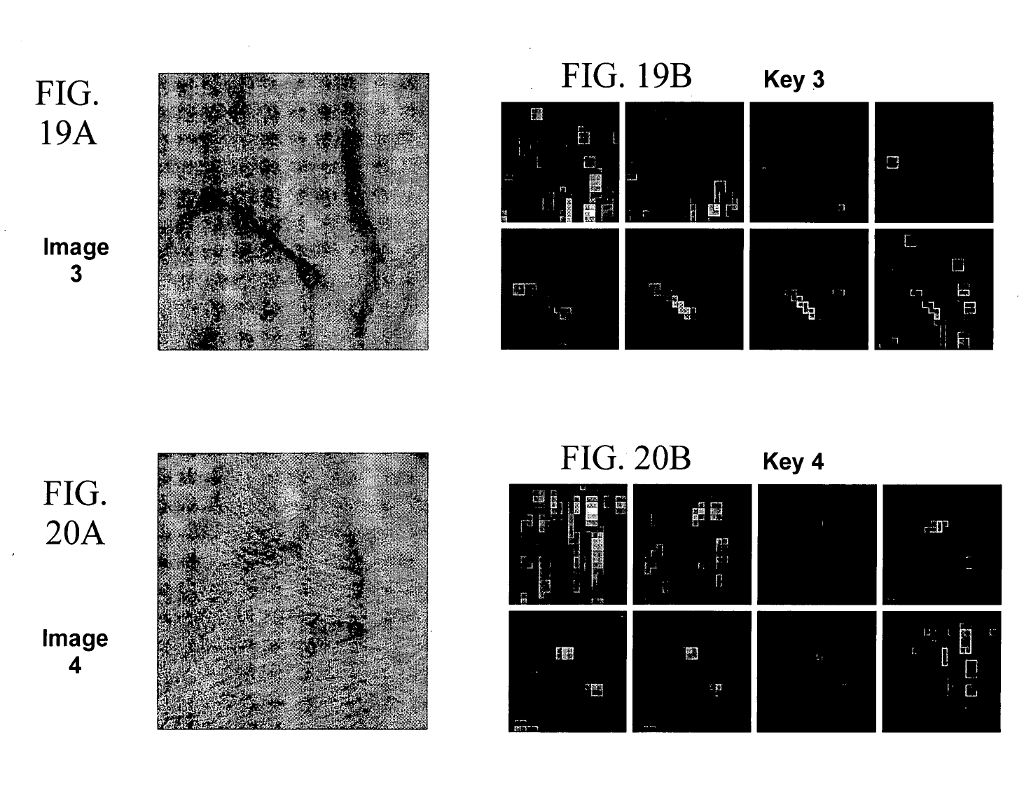

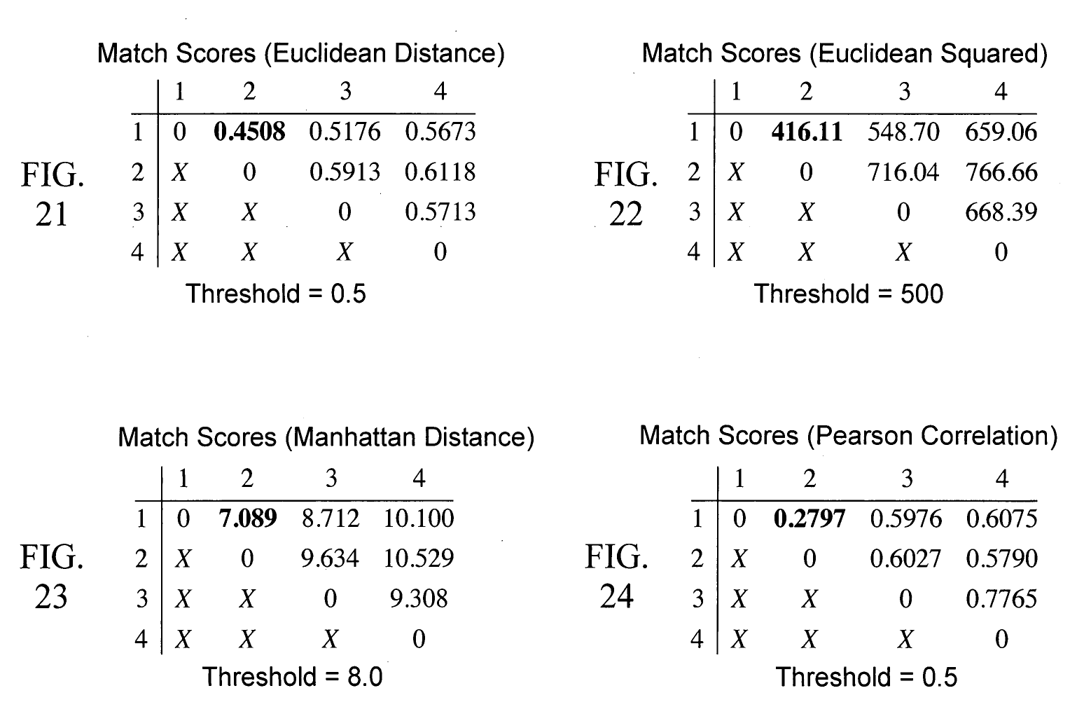

These eight filters were independently applied to each respective image (FIGS. 17A, 18A, 19A, and 20A) to yield eight respective separate filter outputs (FIGS. 17B, 18B, 19B, and 20B). FIGS. 17A and 18A are similar views from the same hand and FIGS. 19A and 20A are from two different hands. FIGS. 21-24 list the scores generated by matching different combinations of these images with different distance metrics, and the threshold for each comparison is shown below each respective table. All match scores in FIGS. 21-23 are normalized (divided) by the length of the key; it is not necessary to normalize the scores for the Pearson Correlation (FIG. 24) because the Pearson Correlation produces normalized scores. The tables of FIGS. 21-24 show that the comparison between two images from the same individual is successful while the others do not match. This also shows that the Pearson Correlation, which is the preferred distance metric, provides the best separation in scores. The reason for this improved performance of the Pearson Correlation distance metric is that it is a normalized metric. Because the input images were not normalized in the pre-processing, the other scoring methods have greater difficulty.

A possible concern with the present invention is its computational complexity. The filters required to perform the feature extraction for an image containing vein patterns are fairly large, and, depending upon the number of filters used (number of orientations and frequencies), the time required to perform the filtering could become problematic. This difficulty can be easily overcome through the application of additional computing power and by using a hardware, rather than purely software, implementation of the computation steps of the present invention. The independent application of multiple filters to an image can easily be implemented in parallel, and thus, lends itself to parallel processing applications. With the multi-core and multi-processor computing platforms currently available in today's computer technology, sufficient computing resources are not an impediment to practice of the invention.

For more rapid key identification/matching, key subsets (“sub-keys”) taken from the filter outputs can be compared separately or even regions within each sub-key can be compared instead of looking at the key as a whole, thereby reducing the computational burden. The results from comparing these key subsets can be used by the matching system independently or recombined to form a single matching score.

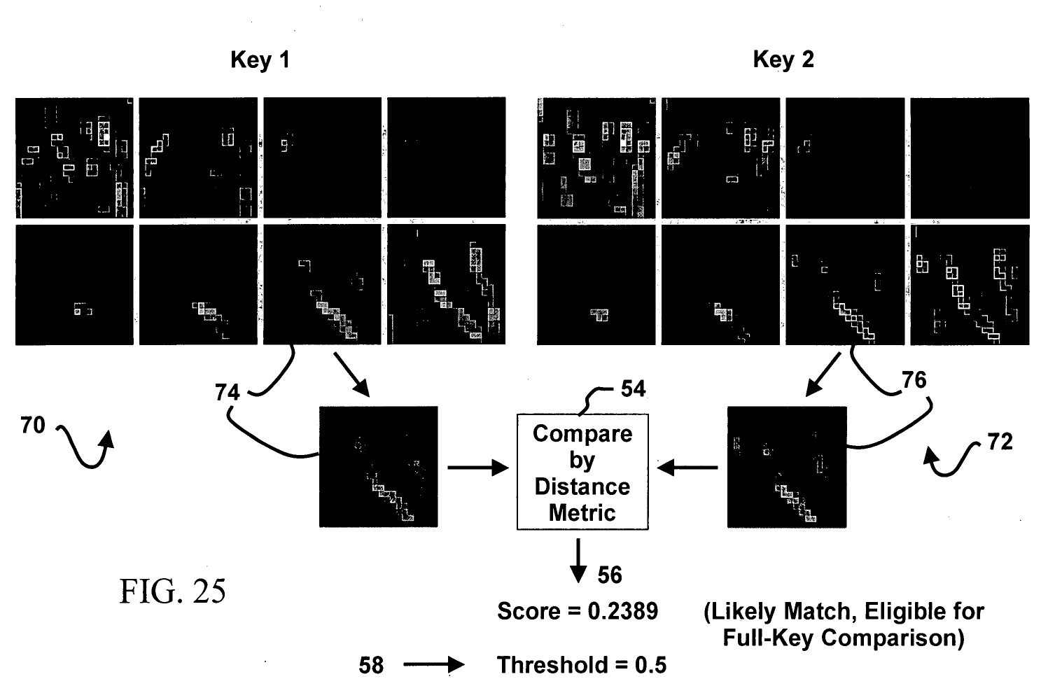

FIGS. 25-28 show preferred embodiments of how partial key matching may be used in accordance with the present invention in order to reduce the computational burden.

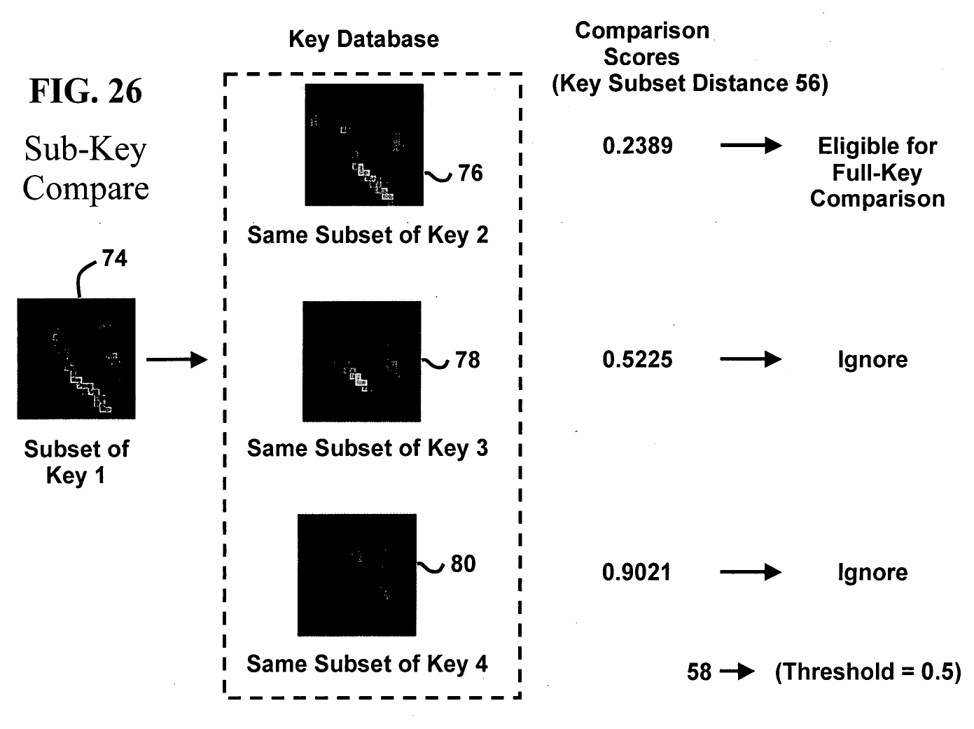

Referring to FIGS. 25 and 26, the first key 70, simply for purposes of explanation, is the same as the key shown in FIG. 17B, and the second key 72 is the same as the key shown in FIG. 18B.

Partial key matching is performed as follows. First, a key subset portion 74 of the input key is selected. In the example shown in FIGS. 25 and 26, the key subset (“sub-key”) 74 generated from the seventh filter output (the filter whose angular orientation is 135 degrees) is selected. In this example, sub key 74 contains 400 values, but, in practice, any subset portion of key 70 of a reasonable size can be used. Once selected, this subset portion 74 of the key 70 is compared 54 to the corresponding portion 76 of the other keys, e.g., key 72, in the key database by using a distance metric, as heretofore described, and the resulting distance scores are noted. For comparison with the earlier-described full-key matching, the example of FIGS. 25 and 26 uses the preferred distance metric of a Pearson Correlation to compare the key subsets 74, 76, 80. If the result of the comparison between a pair of sub-keys results in a distance below a pre-determined first threshold 58 (the example of FIGS. 25 and 26 uses a first threshold of 0.5), then the full keys containing those sub-keys are compared, it being thus determined that a key match is likely and therefore worthy of the computational effort required to do a full key comparison by using a distance metric. This second full-key comparison (performed as heretofore described and shown, for example, in connection with the discussion of FIGS. 21-24) could use the same distance metric as used for the sub-key comparison or a different one, but, in the example of FIGS. 25 and 26, the Pearson Correlation is also used for the second (full key) comparison. If the full key comparison distance is below a second threshold distance (in this case, 0.5), then a match is declared, otherwise the next set of sub-keys is compared. Optionally, instead of comparing the full keys immediately, a list of candidates may be formed and either further reduced by additional partial key matching or processed for full key matching to find the best match. If desired, a list of close matches can be provided to a human operator for further investigation. The use of sub-keys to filter down the set of keys on which to perform full matching provides a substantial savings in computation when employed in large database environments. This form of preliminary comparison can also be used with other final comparison systems. For example, the sub-key matching of the present invention can be used to limit the search space and then a point-based matching algorithm could perform the final comparisons, as explained more fully hereinafter, for greater accuracy.

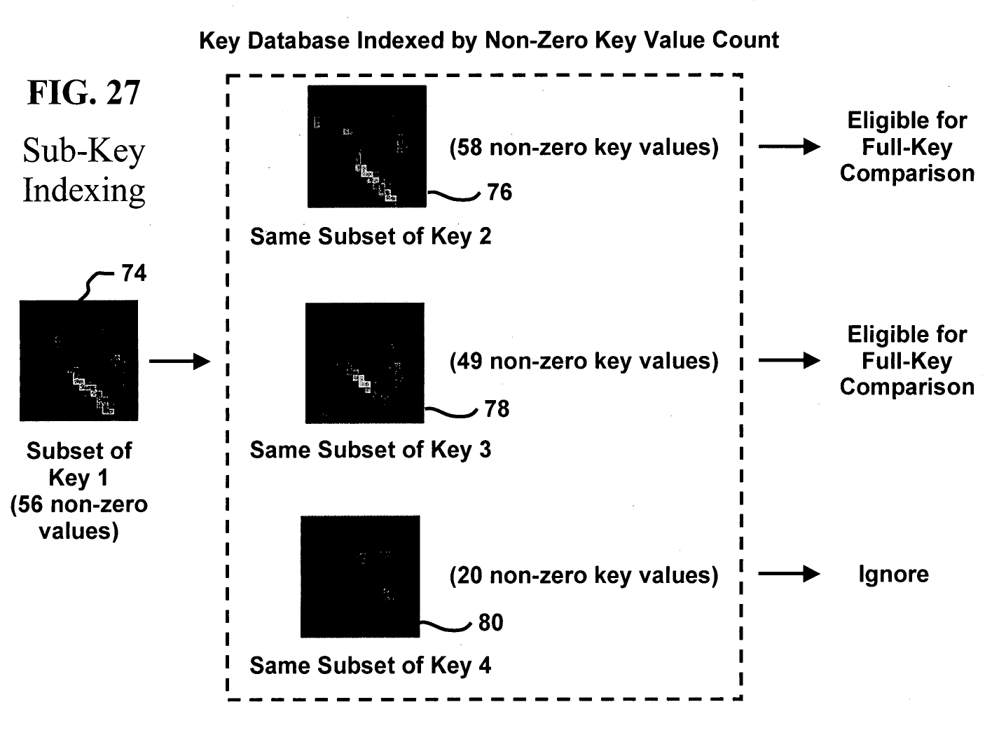

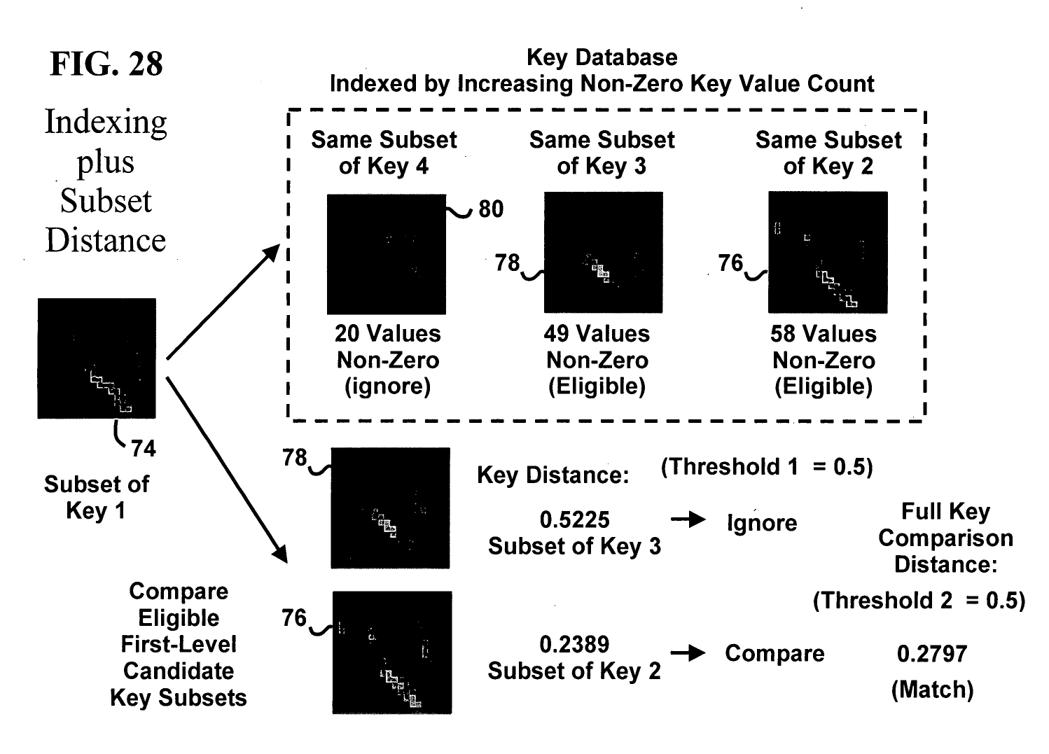

A major benefit of the present invention, as compared to the prior art, is an approach to indexing large databases using a fixed-length key. For example, to reduce the number of computations required to search the database, the key subset values (“sub-keys”) may be pre-indexed to permit the ignoring of keys that are known to have substantially different properties than the current enrollment key, thereby avoiding the computation expense of comparison with these ineligible keys. It should be understood that the pre-indexing of the database to permit rapid ignoring of keys that have substantially different properties than the current enrollment key is equally applicable when the full key is used for the key subset (“sub-key”), such that the database indexing is done based on features of the full key rather than on a proper subset of the full key. However, for purposes of illustration, the examples of indexing are shown using key subsets (“sub-keys”) that are proper subsets of the full keys rather than the full keys themselves. The examples shown in FIGS. 27 and 28 are for a key subset database indexed by decreasing non-zero counts within the key subset cells. As heretofore described, the statistical measure “counts” for each element of the key vector

key₁={x₁, x₂, . . . , xₙ}

may preferably be a statistical variance, and the key indexing examples shown in FIGS. 27 and 28 show that this indexing may be based upon the statistical measures of individual key subsets or even parts of those key subsets. For example, if the maximum variance for a key in question is large in the sub-key related to the filter taken at 45 degrees, comparisons with keys that have little to no variance in that sub-key can be ignored. Other measures can also be used to build indexes to help limit computations such as, for example, the total number of key or sub-key values above or below a given threshold value (the “feature threshold value”), the distance from the zero point, and the current areas of the key containing high or low response values, such that it may be determined whether a group of keys or sub-keys have similar features. It shall be understood that the phrase “having similar features,” when used herein to describe keys and sub-keys, means that the keys/sub-keys have a common measurable characteristic, such as the number of non-zero key values, as a quantifier of biometric information, and that the value of the measured “feature” is similar. As an example of the areas of a key containing high or low response values, the upper right quadrant of a key associated with a filter angle of 45 degrees might contain no normalized key value larger than 25 (out of a range of 0 . . . 255). This would indicate that there is little to no vein presence at that filter orientation in the upper right quadrant of the image. Providing a series of indices constructed from several key features of the keys makes it possible to quickly focus the key matching on the correct subset of keys for full comparison (i.e. those having similar features), thereby drastically reducing search times for large databases of key values.

As specific examples of partial key indexing being used to speed up large database matches, the examples of FIGS. 27 and 28 will now be explained. In the example of FIG. 27, a subset of the full key is examined and features of this key are used to form an index. For comparison with the approach shown in FIGS. 25 and 26, the sub-key portion associated with the seventh filter output is once again used in the examples of FIGS. 27 and 28. By using an index into the key database, key matching can be limited to a subset of the database with keys that have similar features. In the example shown in FIGS. 27 and 28, the number of non-zero key values was used as an indexing measurement and the distance metric was chosen as the Pearson Correlation, which is the preferred distance metric, for comparison with the example of FIGS. 25 and 26. This is done because the number of non-zero key values is representative of the magnitude of the filter response which, in this example using the seventh filter output, is an indicator of the amount of vein detail that runs at an angle of 135 degrees. The example shows that the input image's sub-key 74 has 56 non-zero values. Because the example database is indexed by the number of non-zero sub-key values, it is only necessary to compare the input sub-key 74 to sub-keys with similar properties. If, as the example shows, the range of keys to inspect is limited to those with a non-zero key value count that is within 20 of the input sub-key's count of 56 non-zero values (i.e., within the range 36 to 76), only the key subset 76 for Key 2 and the key subset 78 for Key 3 need to be considered, and the key subset 80 for Key 4 can be ignored because it is not within the selected count distance of 20 of key subset 74 for Key 1. It should be noted that a threshold of zero (i.e., a tally of non-zero statistical measure key value counts) is used in the examples of FIGS. 27 and 28 for the indexing of the key database. However, in practice, any value between the maximum and minimum statistical measure key value counts could be used as, for example, if the database were to be indexed by statistical measure key value counts greater than a threshold of 10 or 20 to require significant filter response before a key cell region is considered meaningful.

While not used in the examples previously discussed, it should be noted that using indexes on multiple sub-keys within the full key or using multiple measures (for example, non-zero value count and mean value or values above a given threshold and variance) for the determination of whether keys or sub-keys have similar features is still within the scope of the present invention, and these techniques can be employed to further limit the search space. Any applicable statistical measure such as, for example, max value, min value, mean value, median value, variance, standard deviation, etc., may be used on a sub-key either alone or in combination as a metric of similar features to limit the search space in a database. Once the search space has been narrowed by database indexes, the field can either be further narrowed using sub-key matching or the remaining keys can be fully compared for a final result. Both of these options are illustrated in the examples shown in FIGS. 25-28.

It should be noted that any number of sub-keys may be extracted and used to narrow the set of candidate keys for final matching. For example, the group of candidates for a full key match could be first narrowed by comparing the portions of the keys that are generated by the 135 degree orientation filter output (as heretofore explained in connection with the example of FIG. 25). The match scores generated from this set of comparisons are then compared to a threshold value, and keys that score outside the threshold are excluded from further consideration. Depending on the size of the remaining candidate set eligible for full-key comparison, it may be beneficial to compare these remaining keys using a different sub-key such as, for example, the portion of the key generated from the 45 degree orientation filter output. This second-level sub-key comparison and subsequent score threshold will result in a further reduction of the candidate set eligible for full-key comparison. This process can then be repeated with additional sub-keys until the candidate set is reduced to a reasonable population for full-key matching.

Along similar lines, indexes generated from sub-keys, as previously described, can be combined to better limit the candidate subset of the database used for full-key matching. For example, an initial first-level index (index one) may be based upon the non-zero element count in a specific sub-key, denoted as sub-key one. By filtering the database to only look at keys with an index value within a certain range of the index generated for a specific candidate key, the search space may be limited. However, if additional indexes are available within the database (index two, three, etc.), these additional indexes may be used to further limit the candidate search set. These additional indexes may be generated using the same feature from different sub-keys (for example, where index two is the non-zero element count for sub-key two), different features for the same sub-key (for example, where index two is the mean value of sub-key one), or a combination of the two (for example, where index two is the non-zero element count of sub-key two and index three is the mean value of sub-key one, etc.). Each additional index within the database can thus serve to provide an additional limitation or reduction of the search space.

These search methods can also be combined. For example, a number of different index values may first be compared to provide a quick candidate search space limitation. Then several partial key matches may be performed to further limit the candidate space eligible for full-key matching. The remaining candidates are then compared with full-key matching. The order in which the index comparisons and sub-key matches occur may be mixed (as, for example, first an index search, then a sub-key match, then another index search, etc.). However, because the index searches involve single-value comparisons, they tend to be faster and less computationally involved than the sub-key matches, and thus it is usually advantageous to perform the index search comparisons first, before the sub-key matches (distance calculations) are done.

Another benefit of the present invention is greater accuracy and speed than heretofore possible in the prior art, when the present invention is used in conjunction with a prior art point-based vein matching system. In such an approach, the fixed length key generated using the present invention is used to quickly limit the search space (as heretofore described, by key subset matching and/or partial key indexing) while the point-based information is used to match the remaining eligible candidates. This permits the present invention to be a valuable tool for one-to-many matches to augment existing 1:1 matching approaches, whereby the present invention is used to quickly select eligible key candidates for comparison, and other (slower) prior art approaches are used to make the final biometric matching determination. As compared to prior art approaches that only use point-based information, the present invention adds additional information to the information available to a point-based approach, leading to more accurate matching. When used as a pure index, the number of filters used can also be reduced to lessen computation time.

There are benefits to be gained by this combination of using the fixed-length keys that are produced by the present invention in conjunction with the information provided by a prior art point-based approach. First, the method used by the present invention for narrowing database searches will allow quicker matching by point-based vein approaches on the resulting eligible candidates, and secondly, the use of the two approaches in combination provides additional biometric detail to the matching process. The present invention's fixed-length keys will quickly match/distinguish based on general texture and flow information while the prior art point-based system will contribute data relating to specific critical points within the image. The result is improved accuracy over either method alone, with the speed benefits provided by the present invention's fixed length key matching.

Although the present invention has been described and illustrated with respect to a preferred embodiment and a preferred use therefor, it is not to be so limited since modifications and changes can be made therein which are within the full intended scope of the invention.

We claim:

1. A method of identifying a person by extracting and matching biometric detail from a subcutaneous vein infrared image of the person, said method comprising the steps of:
(a) filtering said vein image with a first plurality of filters to produce a like first plurality of filtered images;
(b) subdividing each filtered image into a second plurality of regions; each said region having at least one pixel therewithin, each said pixel having an intensity;
(c) for each said region, formatting a statistical measure of the pixel intensities therewithin;
(d) ordering said statistical measures of said regions to define an enrollment key;
(e) comparing said enrollment key to a stored verification key to identify said person by calculating a distance between said enrollment key and said stored verification key and comparing said calculated distance to a threshold distance to decide whether said person is identified.

2. The method as recited in claim 1, said method further comprising, prior to filtering said vein image with said first plurality of filters, preprocessing said image to remove artifacts.

3. The method as recited in claim 2, said method further comprising the step of identifying a region of interest of said vein image.

4. The method as recited in claim 1, said method further comprising the step of identifying a region of interest of said vein image.

5. The method as recited in claim 1, in which at least one said statistical measure is a statistical variance.

6. The method as recited in claim 1, in which at least one said statistical measure is selected from the group consisting of a statistical variance, a standard deviation, a mean, and an absolute average deviation.

7. The method as recited in claim 1, in which said statistical measure comprises a combination of a first measure and a second measure, both selected from the group consisting of a statistical variance, a standard deviation, a mean, an absolute average deviation, a max value, a min value, a max absolute value, and a median value.

8. The method as recited in claim 1, in which said plurality of filters are Even Symmetric Gabor Filters having differing orientation angles.

9. The method as recited in claim 1, in which said plurality of filters are Even Symmetric Gabor Filters having differing spatial frequencies

10. The method as recited in claim 1, in which said plurality of filters are selected from the group consisting of:
(a) Even Symmetric Gabor Filters having differing orientation angles;
(b) Even Symmetric Gabor Filters having differing spatial frequencies;
(c) Complex Gabor Filters;
(d) Log Gabor Filters;
(e) Oriented Gaussian filters; and
(f) Adapted Wavelets.

11. The method as recited in claim 1, in which said calculated distance is a Pearson Correlation Distance.

12. The method as recited in claim 1, in which said calculated distance is a Euclidean Distance.

13. The method as recited in claim 1, in which said calculated distance is selected from the group consisting of:
(a) a Euclidean Distance;
(b) a Hamming Distance;
(c) a Euclidean Squared Distance;
(d) a Manhattan Distance;
(e) a Pearson Correlation Distance;
(f) a Pearson Squared Correlation Distance;
(g) a Chebychev Distance; and
(h) a Spearman Rank Correlation Distance.

14. A method of identifying a person by extracting and matching biometric detail from a subcutaneous vein infrared image of the person, said method comprising the steps of:
(a) filtering said vein image with a first plurality of filters to produce a like first plurality of filtered images, said filters being Even Symmetric Gabor Filters having differing orientation angles;
(b) subdividing each filtered image into a second plurality of regions; each said region having at least one pixel therewithin, each said pixel having an intensity;
(c) for each said region, forming a statistical measure of the pixel intensities therewithin, said statistical measure being a statistical variance;
(d) ordering said statistical measures of said regions to define an enrollment key;
(e) comparing said enrollment key to a stored verification key to identify said person by calculating a distance between said enrollment key and said stored verification key and comparing said calculated distance to a threshold distance to decide whether said person is identified.

15. The method as recited in claim 14, in which said calculated distance is a Pearson Correlation Distance.

16. The method as recited in claim 14, in which said calculated distance is a Euclidean Distance.

17. An apparatus for identifying a person, said apparatus comprising:
(a) means for capturing a subcutaneous vein infrared image of the person;
(b) a first plurality of filters applied to said vein image to produce a like first plurality of filtered images;
(c) means for subdividing each filtered image into a second plurality of regions; each said region having at least one pixel therewithin, each said pixel having an intensity;
(d) means for forming a statistical measure for each region of the pixel intensities therewithin;
(e) means for identifying said person by comparing a first ordering of said statistical measures for each region to a stored second ordering of statistical measures by calculating a distances between said first ordering and said stored second ordering and comparing said calculated distance to a threshold distance to decide whether said person is identified.

18. The apparatus as recited in claim 17, said apparatus further comprising, prior to said first plurality of filters, means for preprocessing said image to remove artifacts.

19. The apparatus as recited in claim 18, said apparatus further comprising means for identifying a region of interest of said vein image.

20. The apparatus as recited in claim 17, said apparatus further comprising means for identifying a region of interest of said vein image.

21. The apparatus as recited in claim 17, in which at least one said statistical measure is a statistical variance.

22. The apparatus as recited in claim 17, in which at least one said statistical measure is selected from the group consisting of a statistical variance, a standard deviation, a mean, and an absolute average deviation.

23. The apparatus as recited in claim 17, in which said statistical measure comprises a combination of a first measure and a second measure, both selected from the group consisting of a statistical variance, a standard deviation, a mean, an absolute average deviation, a max value, a max absolute value, and a median value.

24. The apparatus as recited in claim 17, in which said plurality of filters are Even Symmetric Gabor Filters having differing orientation angles.

25. The apparatus as recited in claim 17, in which said plurality of filters are Even Symmetric Gabor Filters having differing spatial frequencies.

26. The apparatus as recited in claim 17, in which said plurality of filters are selected from the group consisting of:
(a) Even Symmetric Gabor Filters having differing orientation angles;
(b) Even Symmetric Gabor Filters having differing spatial frequencies;
(c) Complex Gabor Filters;
(d) Log Gabor Filters;
(e) Oriented Gaussian filters; and
(f) Adapted Wavelets

27. The apparatus as recited in claim 17, in which said calculated distance is a Pearson Correlation Distance.

28. The apparatus as recited in claim 17, in which said calculated distance is a Euclidean Distance.

29. The apparatus as recited in claim 17, in which said calculated distance is selected from the group consisting of:
(a) a Euclidean Distance;
(b) a Hamming Distance;
(c) a Euclidean Squared Distance;
(d) a Manhattan Distance;
(e) a Pearson Correlation Distance;
(f) a Pearson Squared Correlation Distance;
(g) a Chebychev Distance; and
(h) a Spearman Rank Correlation Distance.

30. An apparatus for identifying a person, said apparatus comprising:
(a) means for capturing a subcutaneous vein infrared image of the person;
(b) a first plurality of filters applied to said vein image to produce a like first plurality of filtered images; said filters being Even Symmetric Gabor Filters having differing orientation angles;
(c) means for subdividing each filtered image into a second plurality of regions; each said region having at least one pixel therewithin, each said pixel having an intensity;
(d) means for forming a statistical measure for each region of the pixel intensities therewithin; said statistical measure being a statistical variance;
(e) means for identifying said person by comparing a first ordering of said statistical measures for each region to a stored second ordering of statistical measures by calculating a distances between said first ordering and said stored second ordering and comparing said calculated distance to a threshold distance to decide whether said person is identified.

31. The apparatus as recited in claim 30, in which said calculated distance is a Pearson Correlation Distance.

32. The apparatus as recited in claim 30, in which said calculated distance is a Euclidean Distance.

33. A method of identifying a person by evaluating an enrollment key against a plurality of stored verification keys, each of said stored verification keys and said enrollment key being of a fixed key length, said method comprising the steps of:
(a) selecting a corresponding verification sub-key from each of said verification keys, each said corresponding verification sub-key being a result of like filtering an image of a respective image of a respective verification individual;
(b) selecting a corresponding enrollment sub-key from said enrollment key in like manner as the selection of said corresponding verification sub-keys, said enrollment sub-key being a result of filtering, in like manner as said filtering for said verification sub-keys, an image of said person;
(c) pairwise comparing said enrollment sub-key to said verification sub-keys by calculating a sub-key distance for each comparison and then comparing said calculated sub-key distance to a first threshold distance; and
(d) only for each said pairwise comparison in which said calculated sub-key distance is not greater than said first threshold distance, comparing said enrollment key to the verification key corresponding to the verification sub-key of said pairwise comparison by calculating a full-key distance between said enrollment key and said verification key corresponding to the verification sub-key, and then comparing said calculated full-key distance to a second threshold distance to decide whether said person is identified.

34. The method as recited in claim 33, in which said calculated sub-key distance is a Pearson Correlation Distance.

35. The method as recited in claim 33, in which said calculated sub-key distance is a Euclidean Distance.

36. The method as recited in claim 33, in which said calculated sub-key distance and said calculated full-key distance are Pearson Correlation Distances.

37. The method as recited in claim 33, in which said calculated sub-key distance and said calculated full-key distance are Euclidean Distances.

38. A method of identifying a person by evaluating an enrollment key against a plurality of stored verification keys, each of said stored verification keys and said enrollment key being of fixed key length, said method comparing the steps of:
(a) selecting a corresponding verification sub-key from each of said verification keys, each said corresponding verification sub-key being a result of like filtering an image of a respective image of a respective verification individual;
(b) forming a database index of features of said corresponding verification sub-keys;
(c) selecting a corresponding enrollment sub-key from said enrollment key in like manner as the selection of said corresponding verification sub-keys, said enrollment sub-key being a result of filtering, in like manner as said filtering for said verification sub-keys, an image of said persons;
(d) using said database index to select verification sub-keys having similar features to said enrollment sub-key;
(e) only for those verification sub-keys having similar features to said enrollment sub-key, comparing said enrollment key to the verification key corresponding to said verification sub-key having similar features by calculating a full-key distance between said enrollment key and said verification key, and then comparing said calculated full-key distance to a first threshold distance to decide whether said person is identified.

39. The method as recited in claim 38, in which said calculated full-key distance is a Pearson Correlation Distance.

40. The method as recited in claim 38, in which said calculated full-key distance is a Euclidean Distance.

41. The method as recited in claim 38, in which said features used for forming said database index are, for each sub-key, the court of sub-key values above a selected feature threshold value.

42. A method of identifying a person by evaluating an enrollment key against a plurality of stored verification keys, each of said stored verification keys and said enrollment key being of a fixed key length, said method comprising the steps of:
(a) selecting a corresponding verification sub-key from each of said verification keys, each said corresponding verification sub-key being a result of like filtering a respective image of a respective verification individual;
(b) forming a database index of features of said verification sub-keys;
(c) selecting a corresponding enrollment sub-key from said enrollment key in like manner as the selection of said corresponding verification sub-keys, said enrollment sub-key being a result of filtering, in like manner as said filtering for said verification sub-keys, an image of said person;
(d) using said database index to select verification of sub-keys having similar features to said enrollment sub-key;
(e) only for those verification sub-keys having similar features to said enrollment sub-key, pairwise comparing said enrollment sub-key to said verification sub-key having similar features by calculating a sub-key distance between said enrollment sub-key and said verification sub-keys having similar features, and then comparing said calculated sub-key distance to a first threshold distance;
(e) only for each said pairwise comparison in which said calculated sub-key distance is not greater than said first threshold distance, comparing said enrollment key to the verification key corresponding to the verification sub-key of said pairwise comparison by calculating a full-key distance between said enrollment key and said verification key corresponding to the verification sub-key, and then comparing said calculated full-key distance to a second threshold distance to decide whether said person is identified.

43. A method of identifying a person by evaluating an enrollment key against a plurality of stored verification keys, each of said stored verification keys and said enrollment key being of a fixed key length, said method comprising the steps of:
(a) selecting a corresponding verification sub-key from each of said verification keys, each said corresponding verification sub-key being a result of like filtering a respective subcutaneous vein infrared image of a respective verification individual;
(b) selecting a corresponding enrollment sub-key from said enrollment key in like manner as the selection of said corresponding verification sub-keys, said enrollment sub-key being a result of filtering, in like manner as said filtering for said verification sub-keys, a subcutaneous vein infrared image of said person;
(c) pairwise comparing said enrollment sub-key to said verification sub-keys by calculating a sub-key distance for each comparison and then comparing said calculated sub-key distance to a first threshold distance; and
(d) only for each said pairwise comparison in which said calculated sub-key distance is not greater than said first threshold distance, performing a point-based pairwise comparison, between the subcutaneous vein infrared image corresponding to said enrollment key and to the verification key for which said pairwise comparison is made, to decide whether said person is identified.

44. A method of identifying a person by evaluating an enrollment key against a plurality of stored verification keys, each of said stored verification keys and said enrollment key being of a fixed key length, said method comprising the steps of:
(a) selecting a corresponding verification sub-key from each of said verification keys, each said corresponding verification sub-key being a result of like filtering a respective subcutaneous vein infrared image of a respective verification individual;
(b) forming a database index of features of said verification of sub-keys;
(c) selecting a corresponding enrollment sub-key from said enrollment key in like manner as the selection of said corresponding verification sub-keys, said enrollment sub-key being a result of filtering, in like manner as said filtering for said verification sub-keys, a subcutaneous vein infrared image of said person;
(d) using said database index to select verification sub-keys having similar features to said enrollment sub-key;
(e) only for those verification sub-keys having similar features to said enrollment sub-key, pairwise comparing said enrollment sub-key to said verification sub-key having similar features by calculating a sub-key distance between said enrollment sub-key and said verification sub-key having similar features, and comparing said calculated sub-key distance to a first threshold distance;
(f) only for each said pairwise comparison in which said calculated sub-key distance is not greater than said first threshold distance, performing a point-based pairwise comparison, between the subcutaneous vein infrared image corresponding to said enrollment key and to the verification key for which said pairwise comparison is made, to decide whether said person is identified.
